(19) United States
(12) Patent Application Publication
(10) Pub. No.: US 2013/0263531 A1
(43) Pub. Date: Oct. 10, 2013

(54) ANCHOR SPIKE FOR LANDSCAPE EDGING

(71) Applicant: EDGETITE PRODUCTS, INC., Orland Park, IL (US)

(72) Inventor: Jeffrey Charles Goodman, Yorkville, IL (US)

(73) Assignee: EDGETITE PRODUCTS, INC., Orland Park, IL (US)

(21) Appl. No.: 13/829,584

(22) Filed: Mar. 14, 2013

Related U.S. Application Data
(60) Provisional application No. 61/686,408, filed on Apr. 5, 2012.

(51) Int. Cl. E02D 5/80; A01G 1/08

(52) U.S. Cl. CPC E02D 5/80; A01G 1/08
USPC 52/155; 52/745.21

(57) ABSTRACT

An anchor spike and a method of using it with landscape edging are provided. The anchor spike has a novel feature that causes the anchor spike to have a changing angle of entry as it is being driven into the ground or other landscape material. The anchor spike is comprised of an elongate shaft, a head located at a first end of the elongate shaft and a tip section located at a second end of the elongate shaft and arranged at an angle to the elongate shaft. The method of using the anchor spike to secure landscape edging to the ground includes arranging a landscape edging strip having a plurality of apertures in a desire location on the ground, providing the anchor spike, aligning the tip section of the anchor spike with an aperture on the landscape edging strip and driving the anchor spike into the ground.

### CROSS-REFERENCE TO RELATED APPLICATIONS

This application claims the benefit of U.S. provisional application No. 61/686,408, filed May 4, 2012, which is hereby incorporated by reference as though fully set forth herein.

### BACKGROUND OF THE INVENTION

a. Field of the Invention

The instant invention relates to anchor spikes for use in landscape edging applications. In particular, the instant invention relates to a directional anchor spike for securing landscape edging holding landscaping and/or paving materials in place. Even more particular, the instant invention relates to a novel directional anchor spike that more securely holds landscape edging against landscaping and/or paving material when driven into the ground.

b. Background Art

Landscape edging has been used in many different landscaping applications in which landscape materials and paving are held in place. One common type of landscape edging consists of elongated strips that are installed along the surface of the ground to create a vertical barrier that can act as a retention and/or a separation of beds of earth or other landscaping fill (i.e., gravel, decorative rock, bark, dirt, sand, mulch, etc.) or the retention of paving materials such as bricks, paving stones, rock, gravel, etc. Edging strips are available in numerous shapes and styles, with many different feature options, and are formed from various types of materials, including, for instance, ridged or semi-ridged plastics or metals.

A very common type of landscape edging system is comprised of an edging strip having at least an L-shape cross-section. In other words, the edging strip has at least one horizontal portion intended to be in contact with the ground and at least one vertical portion that acts as a barrier to landscaping fill or as a retention piece for paving materials. The horizontal portion typically contains apertures at predetermined intervals for anchor spikes or other fasteners that are used to secure the edging strip to the ground. The edging strip could also have a reversed T-shaped cross section or even a cross-shaped cross section. Both alternatives, however, have a horizontal portion intended to be in contact with and pinned to the ground by an anchor spike and the vertical portion that acts as a barrier or retention of landscaping material. Examples of conventional landscape edging strips are shown in U.S. Pat. No. 5,212,917, U.S. Pat. No. 5,240,343, U.S. Pat. No. 5,375,941, U.S. Pat. No. 5,379,546, U.S. Pat. No. 6,071,038 and United States patent publication US 2008/0163566 A1.

While some edging strips are supplied with anchor nails or spikes designed to fit pre-formed apertures on the horizontal portion, most contain standard circular apertures sized to accommodate a standard sized anchor spike. For example, landscape edging strips used to retain pavers are supplied by many different manufacturers with ⅜″ diameter apertures for anchor spikes. Likewise, multiple manufacturers supply anchor spikes having a diameter of 9 mm. The use of standard aperture and anchor spike diameters allows for the components to be interchangeable between manufacturers. Typically anchor spikes have a cylindrical shape, come in various lengths and have a central tip point at one end and a head at the other end. When driven into the ground, the head of the anchor spike is intended to pin the edging firmly against the ground.

One problem with many basic types of landscape edging, especially those used for the retention of pavers, is the inability to install the edging strip tightly against the outer edge of the pavers being retained. In a typical arrangement for a sidewalk using paver bricks, for example, a gravel base is laid on the path for the sidewalk to a depth between 6-12 inches. The base is about 3-6 inches wider on both sides than width of the planned sidewalk. On top of the gravel base is a smaller layer of fine-grade sand extending about the width of the sidewalk, upon which the paver bricks are arranged. The landscape edging is installed on top of the gravel base and against the paver bricks on both sides for the length of the sidewalk. It is not uncommon that the loose gravel from the base or excess sand gets in between the edging strip and the paver bricks, thus preventing the edging from being flush against the paver bricks.

Another problem associated with conventional landscape edging systems is related to the use of the standard cylindrical anchor spikes described above. Standard anchor spikes have a pointed tip at one end formed by chamfering the cylinder on four sides, essentially resulting in a pyramid shape. While installers typically attempt to drive the anchor spikes straight into the ground, the design of the tip can cause it to deflect from that path if it comes into contact with a hard item in the ground. Further, the four-sided nature of the point means that the direction of any deflection is dependent on which side of the tip comes into contact with the hard item in the ground. Installers thus have little control over the direction of the spike as it being driven into the ground. Additionally, a deflection of the spike can cause it to push against the edging strip and move it away from landscaping material sought to be retained. This problem is especially acute with edging used to retain pavers because the anchor spikes are usually driven into the gravel base. Furthermore, because the typical aperture size is larger than the typical anchor spike diameter (by more than 0.5 mm), the aperture cannot sufficiently restrain lateral movement of the anchor spike as it is being driven into the ground.

Over time, the landscape edging will be subjected to forces that will work against the edging's ability to retain the landscaping material or pavers in place. For example, in the case of pavers or gravel, the retained material may be walked on which may cause lateral forces to push the edging outward. Likewise, soil beds or other material may become water logged in heaving rains, causing similar lateral forces to act against the edging. The edging itself may be walked on, kicked or run over by lawn equipment. In winter climates, frost heave, or the freezing and thawing of the earth below and around the edging can be an even greater force acting against the landscape edging.

The freeze/thaw cycle further can cause the anchor spike to rise in the ground as well, ultimately resulting in the head of the anchor spike separating from the landscape edging. The result is that the edging becomes loose, making it susceptible to lateral movement when subjected to the lateral forces of the landscaping material or pavers. The landscape edging thus pulls away from the landscaping material or pavers, causing erosion of the material or movement of the pavers. In the case of pavers, movement of the pavers at the edging may cause the inner pavers to move as well, potentially resulting in the need for an entire installation of a sidewalk, patio or the like to be redone.

Various attempts have been made in the prior art to address the above problems with common landscape edging secured with anchor spikes. At the field level, installers have attempted to drive the anchor spikes into the ground at an angle. This creates further problems, however, regardless of which way the angle of entry is for the anchor spike. First, if the anchor spike is arranged with the direction of entry going away from the paver bricks, for example, then the anchor spike will tend to force the edging strip in that direction while it is being driven into the ground, causing the edging strip to pull away from the pavers. In some cases, driving the anchor spike at an angle towards the pavers may initially move the edging strip tighter against the paver bricks, but as the anchor spike gets closer to the horizontal portion of the edging strip, the striking angle cannot be maintained and the final strikes of the anchor spike cause the edging strip to pull away from the pavers.

Other prior attempts to address the problems described above have involved new designs for edging strips, such as those disclosed in U.S. Pat. No. 6,226,934, or designs involving an integrated edging strip and anchor spike, such as disclosed in U.S. Pat. No. 6,336,290. Others have developed systems having interlocking edging sections rather than edging strips, as disclosed in United States patent application publication no US 2010/0293871 A1. These solutions all require the use of non-conventional edging strips, leading to a more costly installation than is possible with conventional systems. Other solutions have involved the use of anchor spikes with barbs or other protrusions intended to prevent the anchor spike from being pushed out of the ground by frost heave. This solution, however, would require edging strips with apertures sized to accommodate the protrusions on the anchor spikes, such as disclosed in United States patent application publication no US 2008/0163566 A1. This solution too would result in a costlier installation than one where conventional edging strips are used.

Thus, there remains a need to address the problems described above in a simple, cost effective manner.

### BRIEF SUMMARY OF THE INVENTION

In various embodiments, an anchor spike for a landscape edging system can be provided, wherein the anchor spike is configured to cause a landscape edging strip to be installed tighter against retained landscaping material and to provide greater long-term stability to the landscape edging system.

In an embodiment, an anchor spike for use with landscape edging is provided, wherein the anchor spike comprises an elongate shaft, a head located at a first end of the elongate shaft and a tip section located at a second end of the elongate shaft and arranged at an angle to the elongate shaft. In various embodiments, the length of the tip section is between about 10% and about 30% of the length of the elongate shaft and in other embodiments the length of the tip section is between about 15% and about 25% of the length of the elongate shaft. In still further embodiments, the length of the tip section is about 20% of the length of the elongate shaft. The angle between the elongate shaft and the tip section is, in some embodiments, between 10° and 25°. In other embodiments, the angle is about 15°. The angled tip section causes the anchor spike to have a changing entry angle while it is being driven into the ground or other landscape material, such as a gravel base for a brick paver installation.

In another embodiment, an anchor spike for use with landscape edging comprises an elongate shaft having a circular cross-section, a head located at a first end of the elongate shaft and a tip section located at a second end of the elongate shaft and arranged at an angle to the elongate shaft. In some embodiments, the tip section transitions from a circular cross-section to a substantially flat cross-section. The angled tip section causes the anchor spike to have a changing entry angle while it is being driven into the ground or other landscape material, such as a gravel base for a brick paver installation.

An anchor spike for use with landscape edging of another embodiment comprises an elongate shaft, a head located at a first end of the elongate shaft and a tip section located at a second end of the elongate shaft and arranged at an angle to the elongate shaft. In an embodiment, the tip section has a blade edge formed by two chamfered sides. In a further embodiment, the tip section has a blade edge formed by two beveled sides. The angled tip section causes the anchor spike to have a changing entry angle while it is being driven into the ground or other landscape material, such as a gravel base for a brick paver installation.

Another embodiment of an anchor spike for use with landscape edging comprises an elongate shaft having a substantially flat cross-section, a head located at a first end of the elongate shaft and a tip section located at a second end of the elongate shaft and arranged at an angle to the elongate shaft. The angled tip section causes the anchor spike to have a changing entry angle while it is being driven into the ground or other landscape material, such as a gravel base for a brick paver installation.

Still another embodiment of an anchor spike for use with landscape edging comprises two elongate shafts arranged substantially parallel with each other. Both elongate shafts have a tip section located at one end, each tip section arranged at an angle to the respective elongate shaft. A connecting section is attached to both elongate shafts at the ends opposite the tip sections and is configured to cause both elongate shafts to be driven into the ground when struck with a hammer or similar tool. In an embodiment, the connecting section is U-shaped. The angled tip sections cause the anchor spike to have a changing entry angle while it is being driven into the ground or other landscape material, such as a gravel base for a brick paver installation.

A method of securing a landscape edging strip in the ground using an anchor spike of any of the embodiments contemplated herein is also provided. The method comprises the steps of arranging in a desired position on the ground a landscape edging strip having a plurality of apertures for anchor spikes, providing at least one anchor spike comprising an elongate shaft with a head located at a first end and a tip section located at a second end of the elongate shaft, the tip section being arranged at an angle to the elongate shaft, aligning the tip section of the at least one anchor spike with an aperture on the landscape edging and driving the anchor spike into the ground.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a side elevation view of an anchor spike for landscape edging according to one embodiment of the invention.

FIG. 2 is a top view of the anchor spike of FIG. 1.

FIG. 3 is a cross-sectional view taken along line 3-3 of FIG. 2.

FIG. 4 is an enlarged view of the cross-section of the tip from FIG. 3.

FIG. 5A is a representation of a typical installation of a landscape edging system for retaining brick pavers using a prior art anchor spike.

FIG. 5B is a representations of the typical landscape edging system installation of FIG. 5A after a period of time.

FIGS. 6A-6F are a series of representations of a typical landscape edge system for retaining paver bricks using an anchor spike according to one embodiment of the invention, shown at different stages of the installation of the anchor spike.

FIG. 7 is a prospective view of an anchor spike according to another embodiment of the invention.

FIG. 8 is a prospective view of an anchor spike according to still another embodiment of the invention.

### DETAILED DESCRIPTION OF THE INVENTION

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

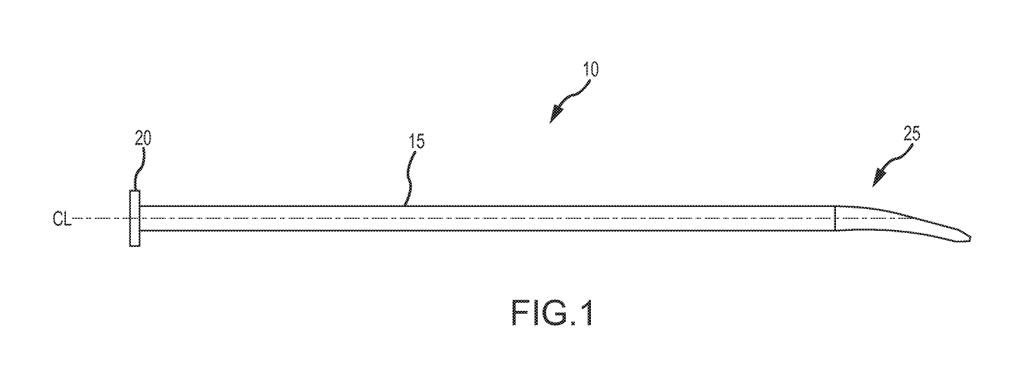

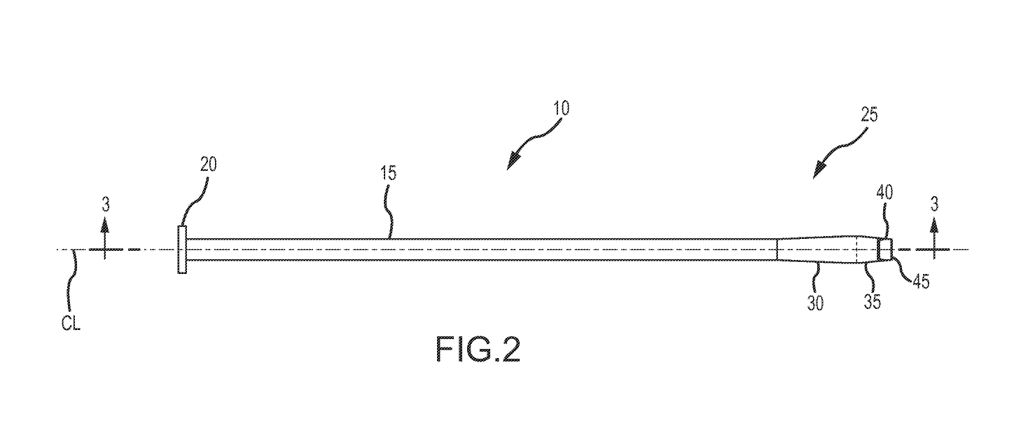

Referring now to the drawings wherein like reference numerals are used to identify the same or substantially similar components in the various views, FIGS. 1 and 2 illustrate a side view and a top view, respectively, of an anchor spike 10 for landscape edging systems according to one embodiment of the subject invention. The anchor spike 10 has a shaft 15, a head 20 at one end and a tip section 25 at the other end. The shaft 15 is cylindrical in shape and has a diameter d. A common diameter for anchor spikes in general is 9 mm, but the instant invention is not so limited and both larger and smaller diameters are contemplated. The head 20 is shown as a flat head but other shapes are possible and the invention should not be considered to be limited to the shape and size shown for head 20.

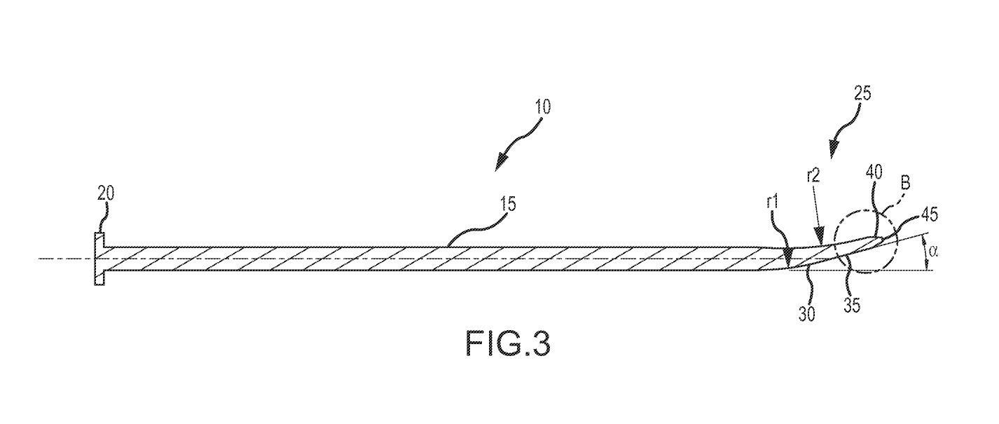

As more clearly seen in FIG. 3, which is a cross-sectional view of the anchor spike 10 taken along line 3-3 of FIG. 2, the tip section 25 is oriented at an angle α with respect to the outer surface of the shaft 15. In the illustrated embodiment, the angle α is about 15°, but in other embodiments the angle may be at least 5° and as much as 30°. Also in the embodiment shown, the transition between the shaft 15 and the tip section 25 is rounded, with the outer edge of the transition having a radius of curvature of r1 while the inner edge has a radius of curvature r2 that is greater than r1. The ratio r2/r1 is about 1.5 in the embodiment, but other embodiments having different ratios are possible and contemplated. In still further embodiments, the transition between the shaft 15 and the tip section 25 may not be rounded.

Referring now to FIGS. 1-3, the length of the tip section 25 is substantially less than the length of the shaft 15. In some embodiments, the tip section 25 has a length between 10% and 30% of the length of the shaft 15. Preferably, the length of the tip section 25 is between 15% and 25% of the length of the shaft 15, and most preferably, the length of the tip section 25 is about 20% of the length of the shaft 15. It should be understood that the invention is not limited to the dimensions and ratios listed, however. For example, it is contemplated that certain installations may be suitable an atypically long anchor spike 10, in which case the tip section 25 may have a length less than 10% of the length of the shaft 15. Likewise, it is also contemplated that a very short anchor spike 10 may be desired, in which case the tip section 25 may have a length greater than 30% of the length of the shaft 15.

The tip section 25 consists of a transition portion 30, a tapered portion 35 and a nose portion 40. One end of the transition portion 30 has a circular cross-section and is connected to the shaft 15. The transition portion 30 gradually transitions to a substantially flat cross section at the opposite end, where it has a width greater than the diameter of the shaft 15 and a height less than the diameter of the shaft 15. The tapered portion 35 is connected to the transition portion 30 at one end where the width of the tapered portion 35 is substantially the same as the width of the transition portion 30. At the opposite end, the tapered portion 35 is connected to the nose portion 40, where it has a width approximately equal to the diameter of the shaft 15. In the embodiment shown, the tapered portion 35 is substantially the same height from the transition portion 30 to the nose portion 40, but in other embodiments the tapered portion 35 may have a smaller height at the nose portion 40 than it has at the transition portion 30.

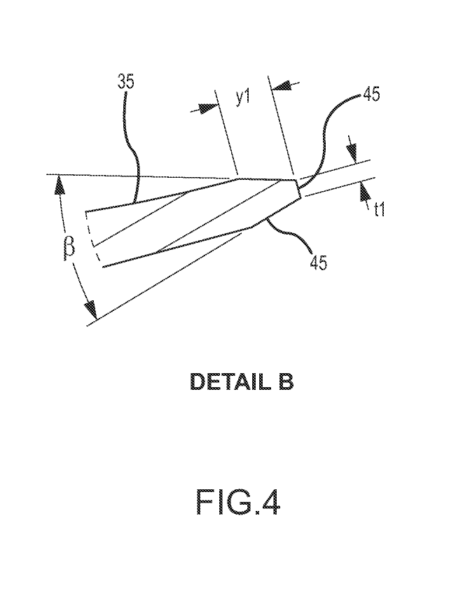

The nose portion 40 is tapered in both height and width from the tapered portion 35 to a blade edge 45 at the outermost end of the anchor spike 10. The width of the nose portion 40, as seen in FIG. 2, is somewhat smaller at the blade edge 45 than at the tapered portion 35. In other embodiments the nose portion 40 can have a substantially constant width across its length. FIG. 4 shows a detailed view of the nose portion 40 shown in FIG. 3. As illustrated, the nose portion 40 is chamfered on two sides between the tapered portion 35 and the blade edge 45. A plane parallel to one chamfered surface of the nose portion forms the angle β with a plane parallel to the other chamfered surface on the nose portion 40. In the embodiment illustrated, the angle β is between 30° and 35°, but other angles are also contemplated.

The blade edge 45 has a height t1, which is less than the height of the tapered portion 35. As depicted, the height t1 of the blade edge 45 is greater than 0 mm, thus creating a blunt surface on the blade edge 45. In another embodiment, the nose portion 40 can be beveled on two sides between the tapered portion 35 and the blade edge 45, causing the height t1 to be substantially 0 mm, thus creating a point at the blade edge 45 across its width.

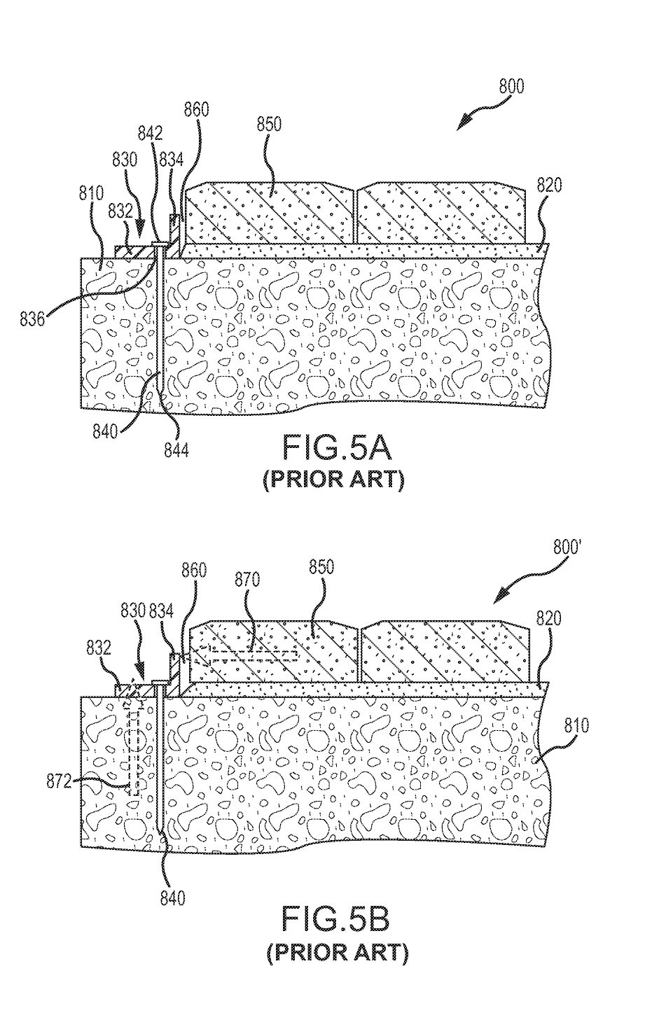

The methods of using a directional anchor spike of any of the above embodiments and the benefits that may be achieved will now be described. First, to provide some additional context, some of the problems that may arise with prior art landscape edging and anchor spikes will be explained. FIGS. 5A, 5B are cross-sectional representations of one edge of a simple installation of a landscape edging system 800 for retaining paver bricks. The installation 800 may be for a sidewalk, driveway, patio or walkway, for example. In the installation 800 there is a gravel base 810, a layer of sand 820, a landscape edging strip 830, an anchor spike 840 and paver bricks 850. In a complete installation there would also be filler sand to fill any gaps between the paver bricks 850, but the filler sand is not shown in this representation. It should be understood that only one edge of the installation 800 is shown and that an edging strip is expected to be on at least a second edge to retain the paver bricks from the opposite lateral direction. In addition, while only two brick pavers 810 are shown, it is expected that additional brick pavers are present in the lateral direction in the installation 800.

The gravel base 810 can have a depth of between 6-12 inches, although other depths are possible as well. The gravel base 810 further extends about 6 to 12 inches wider than the edge of the paver bricks 850. The edging strip 830 can be formed from a variety of materials, including, for instance, ridged or semi-ridged plastics or metals. As shown, the edging strip 830 has an L-shaped cross section and comprises a horizontal portion 832 and a vertical portion 834. The horizontal portion 832 contains an aperture 836 designed to accommodate the anchor spike 840. The anchor spike 840 can be formed from various materials, such as plastics and metals. A typical anchor spike 840 is formed of steal, and more typically, is formed from mild steel. The anchor spike 840 includes a head 842 at one end and a tip 844 at the other end. The diameter of the anchor spike 840 is slightly smaller than the diameter of the aperture 836 in the horizontal portion 832 of the edging strip 830, while the diameter of the head 842 is larger than the diameter of the aperture 836 so that the head 842 can pin the horizontal portion 832 to the gravel base 810 when the head 842 is engaged with the horizontal portion 832.

As depicted in FIG. 5A, the anchor spike 840 has been driven through the aperture 836 and into the gravel base 810. One of the problems associated with common landscape edge systems is demonstrated by the gap 860 existing between the vertical portion 834 and the paver brick 850. The vertical portion 834 was not in tight contact with the paver brick 850 before the anchor spike 840 was driven into the gravel base 810 due to the presence of sand 820. And, because the anchor spike 840 was driven straight down in this example, it could not force the edging strip 830 closer to the paver brick 850.

FIG. 5B shows the same installation 800 of FIG. 5A, but after a period of time. In the installation 800′, the paver bricks 850 have been subjected to environmental forces such as being walked on, which causes a lateral force 870 to be exerted upon the vertical portion 834 of the edging strip 830. Meanwhile, frost heaving has caused a vertically upward force 872 to act against the horizontal portion 832 of the edging strip 830, which in turn pushes the anchor spike 840 out of the ground. As the edging strip 830 becomes unpinned and looser, it is more susceptible to movement, as shown in FIG. 5B. In the scenario depicted, the sand layer 820 has started to erode and the paver brick 850 nearest the edging strip 830 starts to become displaced. Resetting of at least some of the paver bricks 850 and the edging strip 830 will be required to repair the installation 800′.

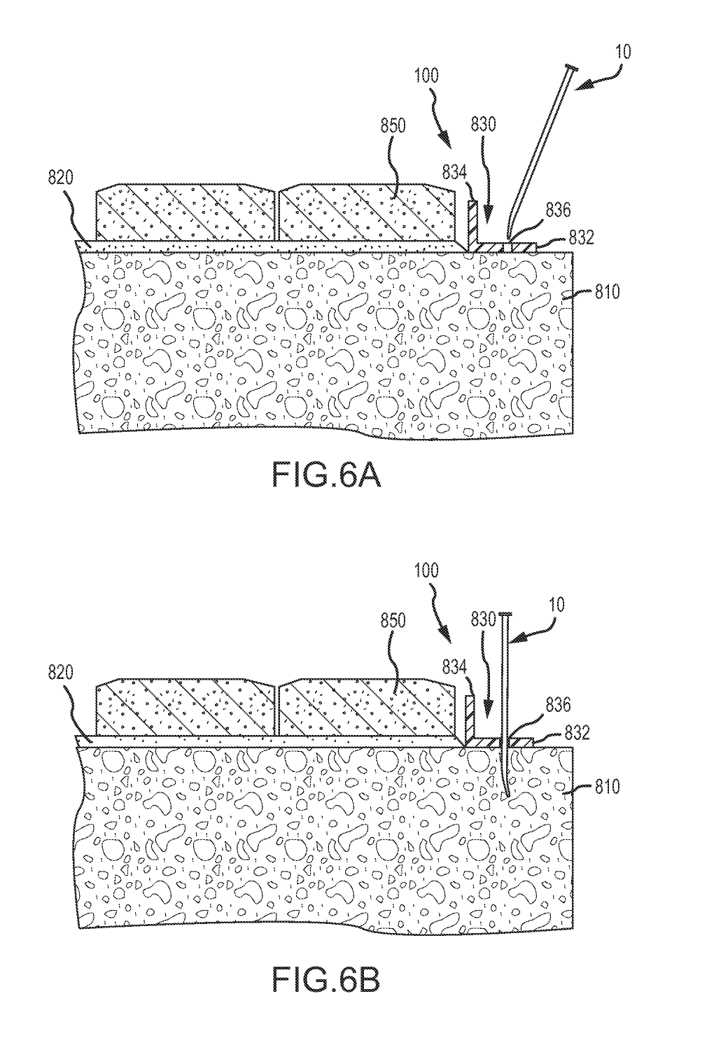

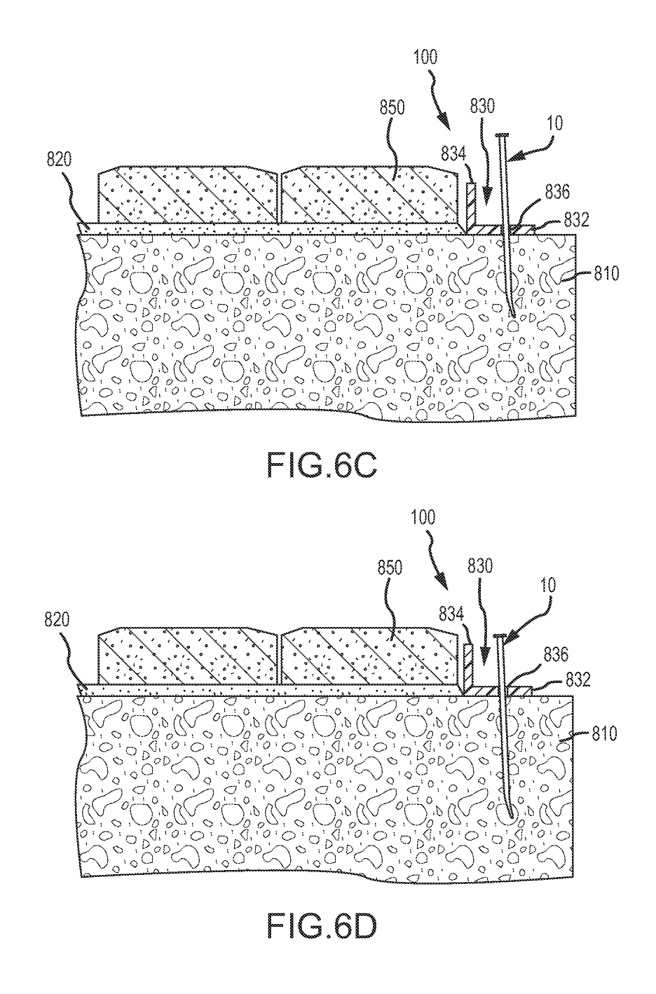

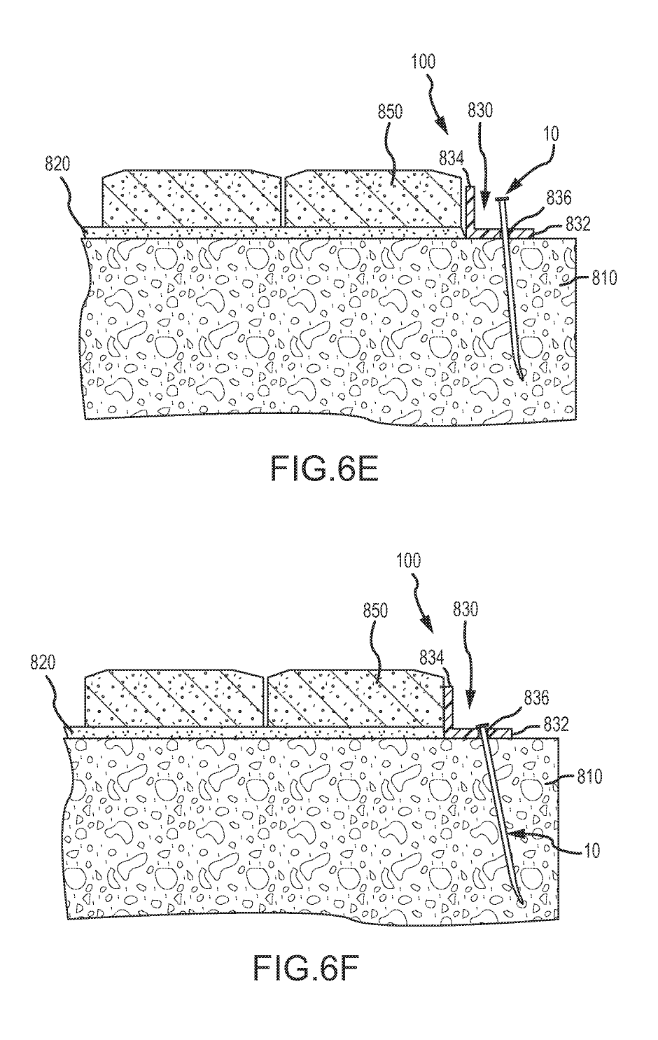

FIGS. 6A-6F illustrate the method and benefits of using the embodiment of an anchor spike 10 described above in a landscape edging system 100 for retaining paver bricks installation having many of the same components as the landscape edging system 800. For example, landscape edging system 100 contains gravel base 810, layer of sand 820, landscape edging strip 830 and paver bricks 850. The difference is that instead of the prior art anchor spike 840, installation 100 includes the anchor spike 10 described above. In the method of use of the inventive anchor spike 10, the anchor spike 10 is aligned with the aperture 836 in the edge strip 834 with the tip section 25 pointing down toward the ground and the shaft 15 at an angle away from the paver bricks 850.

To install from the position illustrated, the anchor spike 10 is first moved downward so that the blade edge 45 is in contact with the gravel base 810 through the aperture 836. The head 20 is then struck by a hammer (not shown) or other similar tool and the anchor spike 10 is driven into the gravel base 810 until the head 20 comes to rest against the horizontal surface 832.

In FIGS. 6B-6F, various positions of the anchor spike 10 while it is being driven into the gravel base 810 are shown. As can be seen through the figures, the angle of entry of the anchor spike 10 through the aperture 836 and into the gravel base 810 changes as the anchor spike 10 is being driven. After the initial strikes with a hammer, the angled tip section 25 causes the anchor spike 10 to straighten and become essentially vertical. With further strikes of a hammer, the anchor spike 10 starts to become angled at the aperture 836 in a direction toward the paver bricks 850. With each successive strike, the tip section 25 causes the anchor spike 10 to be at a greater angle from perpendicular to the horizontal surface 832. The anchor spike 10 also begins to engage the edges of the aperture 836 and, with each successive strike as it is driven further into the gravel base 810, the anchor spike 10 pushes the edge strip 830 closer to the first paver brick 850 until the vertical surface 834 is tight against the paver brick 850, as illustrated in FIG. 6F.

The tight relationship between the vertical surface 834 and the paver bricks 850 help to reduce the risk of erosion and loosening of the installation that can occur when a gap exists between the vertical surface 834 and the paver bricks 850. Furthermore, frost heave will act upon the angled anchor spike 10 in an upward direction, which will not push the anchor spike 10 out of the aperture 836, but rather will act to force the edging strip 830 even tighter against the paver bricks 850. Thus, the anchor spike 10 will be less susceptible to become loose from the freeze-thaw cycle than an anchor spike 840 from the prior art.

While the illustrated embodiments showed a typical installation of a landscape edging system for retaining paver bricks, it should be apparent to one of ordinary skill in the art that the anchor spike 10 may be used with and will be beneficial for many other types of landscape edging system installations. For example, the anchor spike 10 can be used with landscape edging that acts as a border between beds of different landscape materials, such as sod, mulch, gravel or the like. Furthermore, the anchor spike 10 may be beneficial in any type of application where a ground anchor that is more resistant to frost heave is desired.

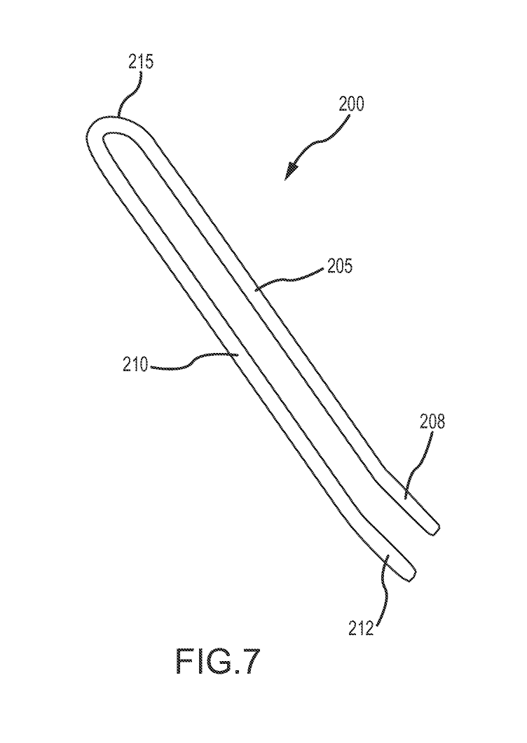

An anchor spike 200 according to another embodiment of the invention is illustrated in FIG. 7. In this embodiment, the anchor spike 200 is comprised of two shafts 205, 210, each having a tip section 208, 210 that is similar to the embodiments described above with respect to tip section 25. At the other end of each shaft 205, 210, instead of a head there is a connection section 215 that joins the two shafts 205, 210 together. The two shafts 205, 210 and connection section 215 can be formed of one piece of material, such as mild steal of other soft, semi-soft or hard metal or plastic, and can be cast, forged, extruded or machined.

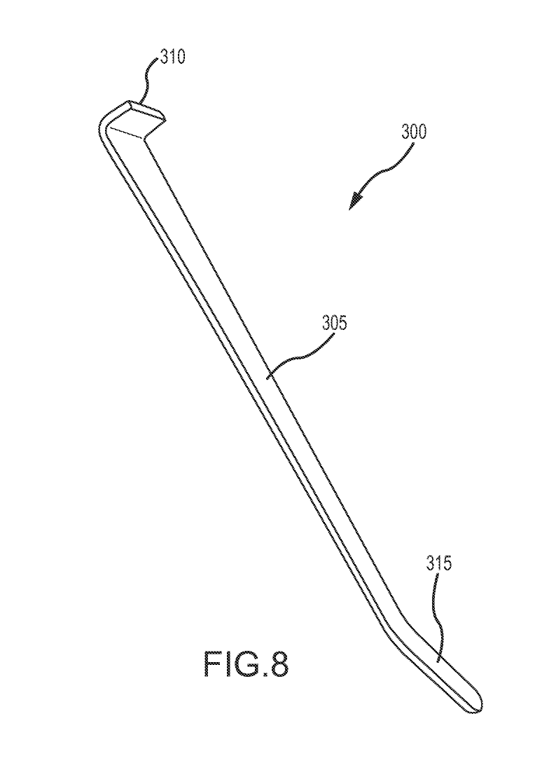

FIG. 8 illustrates another anchor spike 300 according to yet another embodiment of the invention. Here, anchor spike 300 consists of a shaft 305, a head 310 and a tip section 315. Anchor spike 300 differs from anchor spike 10 in that, at least in part, the shaft 305 has a substantially flat cross-section rather than a round cross section as in shaft 15 of anchor spike 10. Tip section 315 is also similar to and has many of the same features as described for the embodiments of tip section 25 of anchor spike 10.

Although various embodiments of this invention have been described above with a certain degree of particularity, those skilled in the art could make numerous alterations to the disclosed embodiments without departing from the spirit or scope of this invention. All directional references (e.g., upward, downward, top, bottom, inner, outer, vertical and horizontal) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An anchor spike for use with landscape edging, the anchor spike comprising:
an elongate shaft;
a head located at a first end of the elongate shaft; and
a tip section located at a second end of the elongate shaft and arranged at an angle to the elongate shaft.

2. An anchor spike according to claim 1, wherein the tip section is configured to cause an angle of entry of the anchor spike to change as the anchor spike is driven into the ground.

3. An anchor spike according to claim 1, wherein the angle between the elongate shaft and the tip section is between 10° and 25°.

4. An anchor spike according to claim 3, wherein the angle between the elongate shaft and the tip section is about 15°.

5. An anchor spike according to claim 1, wherein the elongate shaft has a circular cross-section.

6. An anchor spike according to claim 5, wherein the tip section transitions from a circular cross-section to a substantially flat cross-section.

7. An anchor spike according to claim 1, wherein the length of the tip section is between about 10% and about 30% of the length of the elongate shaft.

8. An anchor spike according to claim 7, wherein the length of the tip section is between about 15% and about 25% of the length of the elongate shaft.

9. An anchor spike according to claim 8, wherein the length of the tip section is about 20% of the length of the elongate shaft.

10. An anchor spike according to claim 1, wherein the tip section has a blade edge formed by two chamfered sides.

11. An anchor spike according to claim 1, wherein the tip section has a blade edge formed by two beveled sides.

11. An anchor spike according to claim 1, wherein the elongate shaft has a substantially flat cross-section.

13. An anchor spike for use with landscape edging, the anchor spike comprising:
two elongate shafts in parallel arrangement, each elongate shaft having a tip section located at one end, each tip section arranged at an angle to the respective elongate shaft; and
a connecting section attached to each elongate shaft at opposite the tip sections, the connecting section configured to cause both elongate shafts to be driven into landscape material when stricken.

14. An anchor spike according to claim 13, wherein the connecting section is U-shaped.

15. A method of securing a landscape edging strip in the ground, the method comprising the steps of:
arranging in a desired position on the ground a landscape edging strip having a plurality of apertures for anchor spikes;
providing at least one anchor spike comprising an elongate shaft, a head located at a first end of the elongate shaft and a tip section located at a second end of the elongate shaft and arranged at an angle to the elongate shaft;
aligning the tip section of the at least one anchor spike with an aperture on the landscape edging;
driving the anchor spike into the ground,
wherein the elongate shaft of the anchor spike pushes against the sides of the aperture while being driven into the ground, causes the landscape edging strip to move in a direction perpendicular to the ground.
